(19) United States
(12) Patent Application Publication
(10) Pub. No.: US 2015/0193875 A1
(43) Pub. Date: Jul. 9, 2015

(54) CREATION PROCESSOR FOR DIVISIBLE INSTRUMENTS

(71) Applicant: Convergent Securities LLC, Franklin Lakes, NJ (US)

(72) Inventor: Gerald C Altomare, Franklin Lakes, NJ (US)

(73) Assignee: CONVERGENT SECURITIES LLC, Franklin Lakes, NJ (US)

(21) Appl. No.: 14/150,013

(22) Filed: Jan. 8, 2014

(51) Int. Cl. G06Q 40/04

(52) U.S. Cl. CPC G06Q 40/04

(57) ABSTRACT

The present invention provides a Creation Processor for Divisible Instrument System, includes apparatus and methods for the creation of divisible financial instruments on an ongoing basis over time. According to the present invention, Financial instruments can be divided after issuance and offered on a continual basis by the issuer upon initial creation and also thereafter over time and are referred to herein as Divisible Instruments.

### FIELD OF THE INVENTION

The present invention generally relates to systems and methods for financial investment. Particular embodiments relate to automated apparatus and integrated software for a novel Creation Processor For Divisible Instruments.

### BACKGROUND

It is a generally known practice for investors to seek to make investments with high returns within a risk profile. Investment considerations may also include other investment characteristics, such as: legal structure, liquidity, transparency, price, growth potential, income potential, regulatory considerations, tax considerations, accounting considerations, and so on, is also well known.

Investments with the flexibility to vary aspects of risk, return and other investment characteristics are generally more attractive to investors compared to investments that are less flexible, in particular if such instruments can be readily valued by investors based upon the value of related instruments.

A bipartite stock certificate (as described in U.S. Pat. No. 4,093,276) created a type of divisible stock certificate which enabled shares of stock issued on an initial offering date to be separated into two parts. During the 1980's such certificates were issued during an initial offering period as redeemable Units which could be divided into separate securities known as Primes and Scores. Once the initial offering period was closed, issuers were unable to increase the number of Units outstanding and faced attrition through redemption. By the early 1990's due to tax inefficiencies and finite offering size these securities were withdrawn from the market.

There remains a need in the marketplace for a way to create of divisible financial instruments on an ongoing basis over time.

### SUMMARY OF THE INVENTION

According to the present invention, a Creation Processor for Divisible Instrument System, includes apparatus and methods for the creation of divisible financial instruments on an ongoing basis over time. Financial instruments that can be divided after issuance and offered on a continual basis by the issuer upon initial creation and also thereafter over time are referred to herein as Divisible Instruments. The components into which Divisible Instruments can be divided are referred to herein as Component Instruments. In some embodiments of the present invention, Divisible Instruments once divided into Component Instruments may be re-combined into Divisible Instruments. In other embodiments, the processes of dividing and re-combining may occur back and forth multiple times, over and over again.

Divisible Instruments and Component Instruments together are referred to herein as Process Instruments. The apparatus for creating Divisible Instruments generally includes a processor in logical communication with a storage device. The storage device stores software code that is executable on command. The processor and software are functional to manifest the concepts and instruments referenced herein.

In another aspect of the present invention, the apparatus used for creating Divisible Instruments may also be capable of redeeming Divisible Instruments, essentially including steps that reverse the process of creation.

Divisible Instruments and Component Instruments may be acquired by investors in multiple ways, including, one or more of: directly receiving the instruments from an issuer; in a secondary market transaction; by dividing Divisible Instruments into Component Instruments; and by combining Component Instruments into Divisible Instruments. In some embodiments, one or more Process Instruments may be publicly listed. In other embodiments, one or more Process Instruments may be privately listed. In some embodiments, Divisible Instruments may be redeemable for underlying assets of the Issuer. In some embodiments, the Divisible Instruments create and redeem for net asset value similar to certain exchange traded funds and certain funds which do not trade.

Apparatus included in a Creation Processor for Divisible Instruments, or Processor, may incorporate computer hardware and stored protocol of processing logic to properly specify the number and kind of Divisible Instruments dividing into Component Instruments.

The Processor is capable of managing individual and multiple instances of creation, division, recombination and redemption simultaneously or in sequence. The Processor organizes and tracks Process Instruments in a database as controlled by the processing logic of the computer system, to insure proper administration of the Process Instruments during their term. The implementation and management of the Processor will affect the pricing efficiency and marketability of Process Instruments.

In some of the embodiments, one part of a Processor includes a data processing system that conveys information about Process Instruments, including valuation information, to the marketplace making such information available in essentially real time, or at least without any significant artificial delays built in.

The Processor and method for executing trades provides for ongoing creations, transformations, trading, managing and reporting of Process Instruments on a seamless, automatic and efficient platform. In some embodiments, the storage device may include a linked database in accordance with a stored protocol. The linked database permits commercial transactions of Process Instruments enabling the distribution and trading of Process Instruments on an ongoing basis. The Process Instruments may be introduced and exchanged in the market either via conventional brokerage services or directly through a trading system, allowing a broad spectrum of investor access to these instruments with improved investment and risk management capabilities compared to other financial instruments.

In one aspect of some embodiments of the present invention, a Processor provides for the division of a single Divisible Instrument into two or more Component Instruments on an ongoing basis with enhanced speed, efficiency and control. In various embodiments, ongoing basis may refer to more than one of a single instance or multiple instances over time.

In one aspect of some embodiments of the present invention, a Processor provides for the combination of two or more Component Instruments into a single Divisible Instrument on an ongoing basis with enhanced speed, efficiency and control. In various embodiments, ongoing basis may refer to more than one of a single instance or multiple instances.

In another aspect of the present invention the Processor provides for the creation of Divisible Instruments on an ongoing basis with enhanced speed, efficiency and control, including means for establishing or identifying the Issuer, means for determining the terms of Divisible Instruments.

In another aspect of the present invention the Processor provides for the creation of Component Instruments on an ongoing basis with enhanced speed, efficiency and control, including means for establishing or identifying the Issuer, means for determining the terms of Component Instruments.

In another aspect of the present invention the Processor provides for the issuance of Divisible Instruments on an ongoing basis with enhanced speed, efficiency, and control.

In another aspect of the present invention the Processor provides for the redemption of Divisible Instruments on an ongoing basis with enhanced speed, efficiency, and control.

In another aspect of the present invention the Processor provides for the issuance of Component Instruments on an ongoing basis with enhanced speed, efficiency, and control.

In another aspect of the present invention the Processor provides for the division of Divisible Instruments into Component Instruments on an ongoing basis with enhanced speed, efficiency, and control.

In another aspect of the present invention the Processor provides for the combination of Component Instruments into Divisible Instruments on an ongoing basis with enhanced speed, efficiency, and control.

In another aspect of the present invention, the Processor provides for the distribution, management and support of Process Instruments on an ongoing basis. Distribution, management and support can be on a periodic basis or on demand. Automated apparatus can provide enhanced speed, efficiency and control, including without limitation: apparatus for receiving, managing and distributing Process Instruments; apparatus for receiving input from the capital markets; apparatus for determining and maintaining terms of dividing Divisible Instruments and combining Component Instruments. In addition, automated apparatus may include means for managing terms associated with Process Instruments, including without limitation: making payments of Process Instruments; extinguishing Process Instruments; providing reporting information for Issuers and to customers for administrative and record keeping purposes including tax reporting; and liquidating an Issuer of Process Instruments.

In accordance with the varying aspects of the present invention, the Process Instrument may be available as a separate trading security. In an associated aspect, the Processor provides trading support for Process Instruments. Trading support may include communicating to investors and potential investors' relevant information to evaluate transactions such as information as to the terms of Divisible Instruments and Component Instruments and as to the terms of division and combination.

The present invention accordingly comprises the features of construction, combination of elements and arrangement of parts that will be exemplified in the following detailed disclosure, and the scope of the invention will be indicated in the claims. Other features and advantages of the present invention will be apparent from the description, the drawings and the claims.

The foregoing specific aspects and advantages of the present invention are illustrative of those which can be achieved by the present invention and are not intended to be exhaustive or limiting of the possible advantages that can be realized. Thus, the aspects and advantages of this invention will be apparent from the description herein or can be learned from practicing the invention both as embodied herein or as modified in view of any variations that may be apparent to those skilled in the art. Accordingly, the present invention resides in the novel parts, constructions, arrangements, combinations and improvements herein shown and described. The present invention has several important technical advantages. In various embodiments it may have none, some, or all of these technical advantages.

### BRIEF DESCRIPTION OF THE DRAWINGS

Embodiments and other aspects of the invention are best understood with reference to the detailed disclosure and the following figures, which are meant to illustrate and not limit the invention, and in which:

FIG. 1 illustrates a block diagram depicting some exemplary embodiments of the present invention including Issuer, Divisible Instrument, Component Instruments and Process Instruments.

FIG. 2 illustrates a flow chart illustrating some methods of creating, dividing, and combining, redeeming, managing, administering and extinguishing Divisible Instruments.

FIG. 3 illustrates a block diagram of a components included in some embodiments the invention.

FIG. 4 illustrates a block diagram of CPU apparatus included in some embodiments the Present invention.

FIG. 5 illustrates an exemplary spreadsheet including sequential events affecting Process instruments.

FIG. 6 illustrates a table with examples of Divisible Instruments and corresponding Component Instruments.

FIG. 7 illustrates an example Reference Linked CIs and Money Market Share DI.

It should be understood by one skilled in the art that the embodiments depicted in the drawings are illustrative and variations of those shown as well as other embodiments described herein may be envisioned and practiced within the scope of the disclosure.

### DETAILED DESCRIPTION OF THE EMBODIMENTS

Accordingly, the present invention provides novel apparatus and methods related to the process of creating on an ongoing basis Divisible Instruments that divide into two or more Component Instruments. This is accomplished using an innovative Creation Processor For Divisible Instruments to create Divisible Instruments with defining characteristics that divide into Component Instruments each comprising different characteristics of the Divisible Instrument from which the Component Instruments derived. In some embodiments the Processor can create Divisible Instruments comprising fund shares redeemable for the net asset value of a fund.

According to the present invention, a specified Divisible Instrument divides into Component Instruments according to an instance of division and specified Component Instruments combine into a Divisible Instrument in an instance of combination. The relative value of the Divisible Instrument is determined by market demand and the value of such instrument is efficiently determined by the value of the Component Instruments comprising it. In the case of a redeemable Divisible Instrument its value is efficiently determined by the value of the assets for which it can be redeemed.

In a similar fashion, the aggregate value of the Component Instruments comprising the Divisible Instrument can be imputed from the value of the assets for which the Divisible Instrument can be redeemed.

The process of creating Divisible Instruments allows for the creation of new and improved financial instruments which are Component Instruments with enhanced flexibility to allocate risk and return. The process of creating Divisible Instruments on an ongoing basis using the Creation Processor for Divisible Instruments enables issuers to respond to market demand for such enhanced flexibility by increasing and decreasing their assets and outstanding Process Instruments with flexibility and efficiency.

As a result of the methods and apparatus disclosed, investors, dealers and Issuers will benefit from: improved issuance flexibility compared to divisible instruments that cannot be offered continuously; new methods and apparatus for managing risk and return; superior ability to match supply with market demand; efficiency in trading; increased trading opportunities; amongst other benefits.

Process Instruments can be traded via the apparatus and methods described herein using U.S., non U.S. and global, public and private markets, exchanges, services and platforms, among others, including examples such as the New York Stock Exchange, NASDAQ, the London Stock Exchange, the Cayman Islands Stock Exchange, Bloomberg® and Reuters® pages, the NASDAQ PORTAL Alliance system, and private dealer markets, among others.

In some embodiments of the present invention, a newly formed special purpose vehicle (SPV), a corporation, holds cash collateral and continuously creates Divisible Instruments being equity shares redeemable for cash that divide reversibly into two Component Instruments. The Component Instruments may have a term of two years and inverse payoffs linked to inflation for example. Should the market value of the Divisible Instrument vary from the aggregate value of the Component Instruments arbitrage opportunities would exist to bring the relative price of the Divisible Instrument and the Component Instruments into balance.

In another example, an SPV trust holding gold ounces continuously issues equity units as Divisible Instruments dividing into three disparate Component Instruments: Component Instrument A pays the value of gold up to a first threshold; Component Instrument B pays the value of gold from the first threshold to a second threshold; and, Component Instrument C pays the value above the second threshold.

The present invention provides a Creation Processor For Divisible Instruments apparatus capable of creating, distributing, managing, and maintaining a plurality of Process Instruments and executing trade, transformation, issuance and extinguishment of such Process Instruments. Process Instruments provide the ability to own and trade financial instruments having enhanced investment flexibility compared to other investment opportunities.

A Creation Processor For Divisible Instruments is employed as part of a Creation Processor for Divisible Instrument System and includes processors in logical communication with executable code which upon execution causes the processor to be functional to one or more of: create, distribute, manage, maintain, transform, and extinguish the Process Instruments.

A data processor according to the present invention makes possible a fundamentally new way to create divisible instruments on an ongoing basis, and to facilitate the trading of Process Instruments, the division and redemption of Divisible Instruments, and the combining of Component Instruments thereby facilitating pricing arbitrage and efficient market pricing.

In some respects, Process Instruments may resemble other instruments which investors may be familiar with; however, Process Instruments differ in their ability to be divided and combined and therefore have the advantage of being both familiar to investors and superior in their investment flexibility. The Process Instruments are familiar in terms of the kinds of structures that investors become involved with from a tax and regulatory perspective and offer the same feeling of financial soundness plus the benefits of Transformation. The Creation Processor For Divisible Instruments is designed to reinforce and confirm these impressions among investors by facilitating the basic functions necessary for the Process Instrument's comparability and advantages compared with other Financial Instruments.

Apparatus and executable code utilized to process or create Process Instruments may take into account multiple factual considerations in order to optimize the success of a Process Instrument offering. Considerations may include, for example, one or more of: a ratio of Divisible Instruments to Component Instruments; administration of changes to one or more of the Process Instruments; cash and/or physical settlements; and expense and income attributions.

According to the present invention, the above functions and other aspects are realized in a Creation Processor For Divisible Instruments including apparatus and executable software. A Process Instrument Data Processor is linked to a database for managing the ongoing creation of Divisible Instruments and other aspects of managing Process Instruments. Investors become holders of Process Instruments having dividing and combining value by virtue of their ability to be Divisible Instruments or Component Instruments and the attribution of Issuer-related income, expenses or corporate actions or otherwise.

In various embodiments Investors effect the creation and redemption of Divisible Instruments in exchange for the depositing or withdrawing assets comprising Issuer net asset value thereby connecting the value of Process Instruments to the value of the Issuer's underlying assets.

In various embodiments, a Process Instrument database includes digital data descriptive of at least one account and Process Instrument information and stores parameters that govern creation and redemption of Divisible Instruments and combination and division of Process Instruments as well as terms of Process Instruments, including expense attribution, on a periodic basis as controlled by processing logic inherent in the executable software. The system provides for the creation of Divisible Instruments by enabling newly created and issued instruments and outstanding instruments to be Divisible Instruments.

### Overview

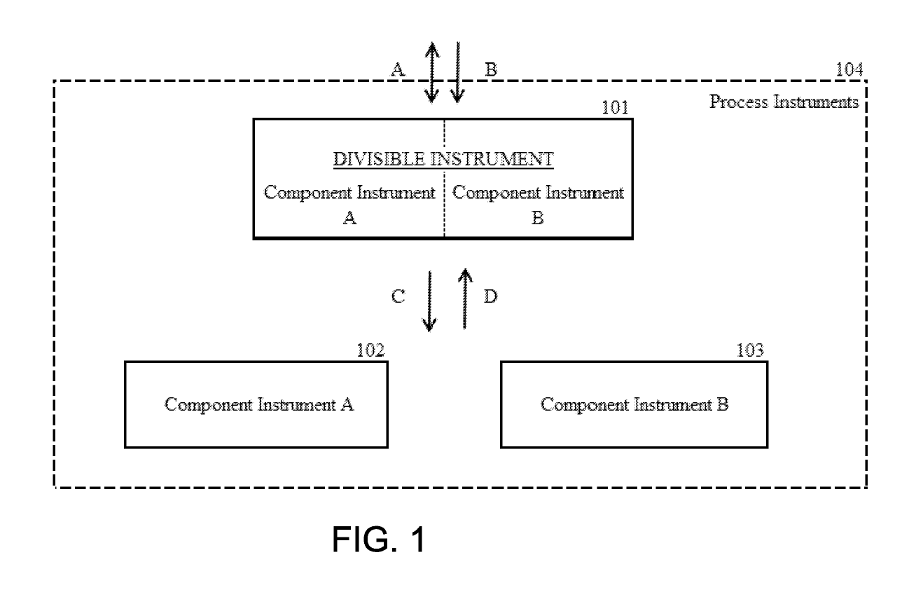

Referring now to FIG. 1, Issuer 100, being any form of financial instrument issuer, creates and issues on an ongoing basis initially and over time Divisible Instrument 101 a single financial instrument dividing into Component Instrument A 102 and Component Instrument B 103, where Divisible Instrument 101, Component Instrument A 102 and Component Instrument B 103 comprise Process Instruments 104. Arrows A is used to depict Divisible Instrument 101 as a redeemable instrument of Issuer 100 and Arrow B depicts Divisible Instrument 101 as an instrument of Issuer 100 not redeemable. Whether or not Divisible Instrument 101 is specified by the System as a redeemable instrument according to Arrow A or a non-redeemable instrument according to Arrow B depends primarily on market demand and the objectives of the Issuer.

Typically, redeemable issuances are more attractive in that they provide investors with another means to realize value in addition to trading or ordinary distributions. Arrow C depicts a dividing process involving Process Instruments 104 whereby the division of Divisible Instrument 101 into Component Instrument A 102 and Component Instrument B 103 takes place, and Arrow D depicts a combining process involving Process Instruments 104 whereby the combination of Component Instrument A 102 and Component Instrument B 103 into Divisible Instrument 101 takes place. It is understood that dividing processes and combining processes can be specified where Process Instruments include one Divisible Instrument and more than two disparate Component Instruments.

### Methods

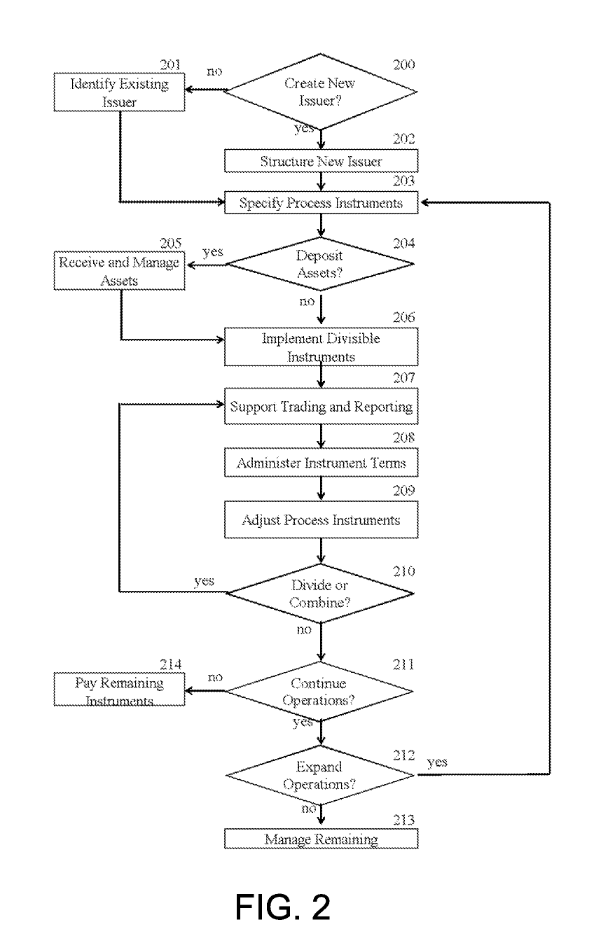

Referring now to FIG. 2 at 200 an initial depositor or creator, such as a sponsor, promoter, investment banker or issuer evaluates creating a new Issuer to offer Divisible Instruments considering whether the instruments will satisfy primarily investor or issuer needs. If the determination is to create a new issuer, step 201 comprises activities to identify an existing company, special purpose vehicle or other entity as Issuer 100 issuing new Divisible Instruments or converting existing instruments into Divisible Instruments. In some embodiments the issuer is identified in part based on its ability to benefit from Divisible Instruments including generating fees, improving the liquidity of its issuances and increasing market interest of its offerings among others. If the determination is made to create a new issuer, step 202 comprises investment banking activity aimed at structuring and creating Issuer 100 issuing new Divisible Instruments that can be issued initially and on an ongoing basis over time.

Such processes contemplate considerations of market demand, legal, tax, regulatory and other issues affecting the proper structuring of the issuer. Issues relating to market demand might include, among others, the likelihood and amount of ongoing investor interest there might be to create Divisible Instruments on an ongoing basis. Processes may also relate to issues relating to legal, tax, regulatory and other issues including, among others, for example, the feasibility, practicality and cost of creating Divisible Instruments on an ongoing basis.

At 203, Issuer 100 specifies Process Instruments. In one example, the Issuer 100 is a new special purpose vehicle and the Process Instruments specified include one or more of: Divisible Instrument 101 a single share of equity, Component Instrument A 102 a right to dividends from equity share Divisible Instrument 101 and Component Instrument B 103 a right to all other characteristics of equity share Divisible Instrument 101. It is appreciated that Divisible Instrument 101 may be structured to reflect the economics of assets held or not held by the issuer such as the dividends and appreciation of one or more shares of IBM stock or a portfolio of shares of stock of one or more issuers.

In another example, an issuer is an existing fund with one class of unit outstanding that the issuer specifies to be Divisible Instrument 101 divisible into specified Component Instrument A and specified Component Instrument B. Step 203 also includes specifying whether Divisible Instrument 101 is a fund interest requiring that cash assets or other assets be deposited for future distribution upon redemption.

At 204, if assets are to be deposited, the deposit may involve analyzing the investment characteristics of said assets including whether the assets are hard assets or financial assets and any applicable factors such as liquidity, transferability, maturity, coupons, dividends, settlement, payment dates, ratings and market capitalization and estimates as to the timing and amount of payments produced under a variety of scenarios.

At 205, if the determination is yes, said assets may be received and managed by the issuer or the issuer's agent. In the case of newly issued Divisible Instruments, the issuer may receive assets or the cash equivalent amount used to acquire assets in this step. In the case of existing instruments which may not initially be Divisible Instruments but are converted into Divisible Instruments, the issuer may use existing funding to acquire said assets if said assets are not already owned by the issuer. The management of the assets is affected by the issuer or a representative of the issuer and may included active management, passive management or no management at all. If the determination in Step 204 is not to deposit assets then the issuer's obligation to redeem Divisible Instruments may be based on the issuer's credit, a third party guarantee or otherwise. An exchange traded note which is a Divisible Instrument would be an example where the issuer's credit would support the issuer's obligation to redeem.

At 206, Divisible Instruments 101 may be implemented in the marketplace initially, and on an ongoing basis over time. In the case of newly issued Divisible Instruments the instruments are distributed into the marketplace by offering or otherwise. In the case of existing instruments that are not Divisible Instruments, but are converted into Divisible Instruments, these instruments become Divisible Instruments 101 in this step.

At 207, the issuer may support one or more of: trading, reporting and tracking of Divisible Instruments and any Component Instruments created from the division of Divisible instruments in later step 210. This may include the use of electronic computing and networking technologies enabling automated means to perform computation and data processing to support the trading of Process Instruments and reporting of financial documents, financial analysis, market-based valuations, computerized division and combination of Process Instruments and redemption and creation of Divisible Instruments, and support for various markets including options, futures and lending products and markets tied to Process Instruments.

At 208, the issuer administers terms of the Process Instruments. Terms may include making payments due under the Process Instruments 104. The payments may include interest payments, dividend payments, payments in settlement of options or forwards or any other distribution required under the terms of the Process Instruments.

At 209 the issuer makes adjustments if any, to the terms of Divisible Instruments and Component Instruments, including effect this may have on the dividing of Divisible Instruments and the combining of Component Instruments. Adjustments may include the price or quantity of assets which Divisible Instruments create for or redeem for in the event of Divisible Instruments being redeemable. Adjustments may affect the terms of division and combination of Process Instruments. These may be affected by the cost of administering the system or for corporate events including splits, payments in kind, liquidating dividends, net settlement of contracts for any other occurrences that impact structure or terms of Process Instruments.

At 210, Divisible Instruments may be divided or Component Instruments may be combined. In the event that the decision to divide or combine is yes support and trading for the resulting Process Instruments resumes at 207. In certain embodiments, division may be automatic where a Divisible Instrument owner sells a Component Instrument and combination may be automatic where the owner of Component Instruments sells a Divisible Instrument.

At 211, a decision may also be made as to whether or not to continue operations. If the determination is made to not continue operations, remaining Process Instruments are paid in Step 214, which may include payment through redemption in the case of Process Instruments that are individually or jointly redeemable, and the Issuer's use of Process Instruments is terminated.

At 212, if a determination is made to continue operations, then another determination may be made as to whether to expand operations or to not expand operations. If the determination is made to expand operations then the process may be restarted at step 203. In the event that the determination is made to not expand operations then any remaining Process Instruments and associated assets may be managed for the benefit of remaining owners until an expiration, if applicable, of said Process Instruments. If the determination is made to not expand operations then management of remaining instruments continues in 213.

In some embodiments, an issuer of Process Instruments may, from time to time, reset the terms of the Process Instruments through corporate actions or otherwise. Resetting may take place, for example, in order to remain competitive in the marketplace. For example, resetting may be done periodically or in response to economic factors that undesirably alter the attractiveness of the Process Instruments as an investment. Resetting may also be done for example to reduce the cost of a Divisible Instrument that is a share of stock through a stock split. Such an event will have ramifications for the division and combination of Component Instruments requiring adjustments within the System. For example, if the Divisible Instrument is split, the Component Instruments may be split as well, otherwise Component Instruments may be devalued relative to Divisible Instruments.

In still other embodiments, the function of establishing the Process Instruments and dividing and combining instances may be accomplished and managed by the Creation Processor for Divisible Instruments in accordance with those methods outlined in example of FIG. 2. The operation of this system may include a communications mechanism between the various entities identified in FIG. 2. This communications mechanism may encompass any and all apparatus for conveying information from one place to another including, for example, wireless communications, wired communications, computer networks, fiber optics, and others.

### Apparatus

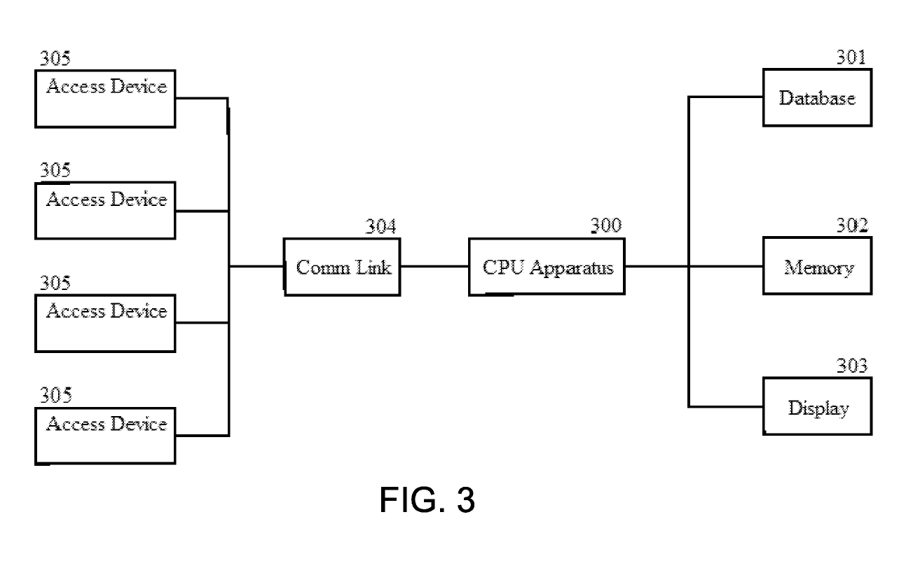

Referring now to FIG. 3, exemplary apparatus with which the present invention may be implemented is presented in block form, generally highlighting the components of a computer system adapted and configured for implementing the innovative aspects discussed herein. In some embodiments, a computer system can include a central processor (CPU) 300 linked to a main database 301.

The main database includes archival data associated with the various instruments, customers and assets, and allows proper manipulation of the underlying parameters in accordance with system logic. The database structure is outlined in detail in the database structure section below. The logic controlling the system operation may be stored in discrete memory 302.

A user interface may be presented on the display 303. The user interface includes one or both of human readable graphics and text which represent data included in one or both of the main database 301 and the discrete memory.

One aspect of the foregoing system involves the input of information into the apparatus that may affect or determine the price of Process Instruments such as information concerning the terms, issuance, division, combination, redemption and management of Process Instruments. Accordingly, the system apparatus includes at least one communication link 304 to a network for proper controlled communication to various institutions, investors or other participants involved in Process Instruments. Such participants utilize access devices 305 such as one or more of: personal computers, laptops, pad devices, mobile phone devices and workstations located at remote locations, but in communication with the CPU 300. It is expected that one or more of the Issuers, the depositor, the reference information provider(s), the brokers handling transactions with investors, the investors themselves and others, will each respectively communicate with a System.

System apparatus can include digital electronic circuitry included within computer hardware, firmware, software, or in combinations thereof. Additionally, aspects of the invention can be implemented manually.

Apparatus of the invention can be implemented in a computer program product tangibly embodied in a machine-readable storage device for execution by a programmable processor and method actions can be performed by a programmable processor executing a program of instructions to perform functions of the invention by operating on input data and generating output. The present invention may be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired, and in any case, the language can be a compiled or interpreted language. Suitable processors include, by way of example, both general and special purpose microprocessors.

Generally, a processor will receive instructions and data from a read-only memory and/or a random access memory. Generally, a computer will include one or more mass storage devices for storing data files; such devices include magnetic disks, such as internal hard disks and removable disks magneto-optical disks and optical disks. Storage devices suitable for tangibly embodying computer program instructions and data include all forms of non-volatile memory, including, by way of example, semiconductor memory devices, such as EPROM, EEPROM, and flash memory devices; magnetic disks such as, internal hard disks and removable disks; magneto-optical disks; and CD_ROM disks. Any of the foregoing can be supplemented by, or incorporated in, ASICs (application-specific integrated circuits).

In some embodiments, implementation of the features of the present invention is accomplished via digital computer utilizing uniquely defined controlling logic, wherein the computer system includes an integrated network between and among the various participants in Process Instruments.

The specific hardware configuration used is not particularly critical, as long as the processing power is adequate in terms of memory, information updating, order execution, redemption and issuance. Any number of commercially available database engines may allow for substantial account coverage and expansion. The controlling logic may use a language and compiler consistent with that on the CPU 300. These selections will be set according to per se well-known conventions in the software community.

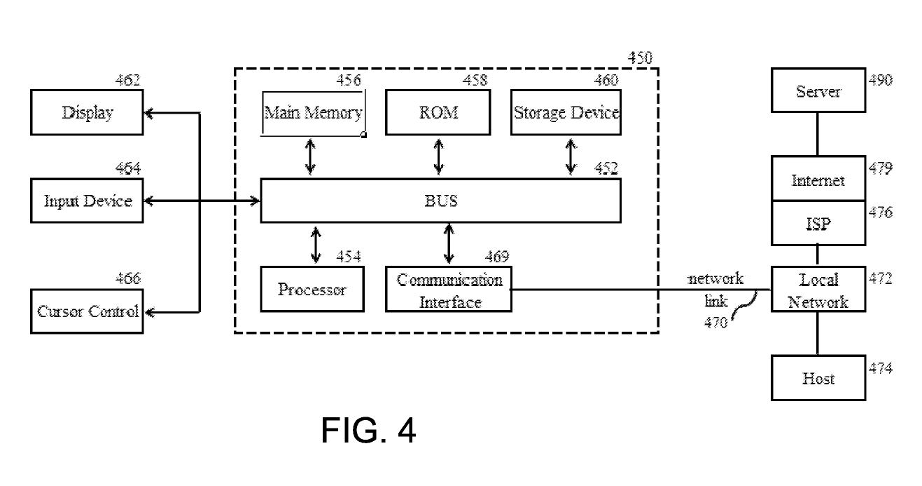

Referring now to FIG. 4, additional aspects of computer hardware useful for implementing the present invention are illustrated as a block diagram that includes a computer system 450 upon which an embodiment of the invention may be implemented. Computer system 450 includes a bus 452 or other communication mechanism for communicating information, and a processor 454 coupled with bus 452 for processing information. Computer system 450 also includes a main memory 456, such as a random access memory (RAM) or other dynamic storage device, coupled to bus 452 for storing information and instructions to be executed by processor 454. Main memory 456 may also be used for storing temporary variables or other intermediate information during execution of instructions to be executed by processor 454. Computer system 450 further includes a read only memory (ROM) 458 or other static storage device 460, such as a magnetic disk or optical disk, may be provided and coupled to bus 452 for storing information and instructions.

Computer system 450 may be coupled via bus 452 to a display 462, such as a cathode ray tube (CRT) or liquid crystal display (LCD), for displaying information to a computer user. An input device 464, including alphanumeric and other keys, may be coupled to bus 452 for communicating information and command selections to processor 454. Another type of user input device is cursor control 466, such as a mouse, a trackball, a touchpad, or cursor direction keys for communicating direction information and command selections to processor 454 and for controlling cursor movement on display 462. This input device typically has two degrees of freedom in two axes, a first axis (e.g., x) and a second axis (e.g., y), that allows the device to specify positions in a plane.

Embodiments of the invention are related to the use of computer system 450 for Process Instruments. According to one embodiment of the invention, Process Instruments are defined and managed by computer system 450 in response to processor 454 executing one or more sequences of one or more instructions contained in main memory 456. Such instructions may be read into main memory 456 from another computer-readable medium, such as storage device 460. Execution of the sequences of instructions contained in main memory 456 causes processor 454 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 454 for execution. Such a medium may take many forms, including but not limited to, non-volatile media, volatile media, and transmission media. Non-volatile media includes, for example, optical or magnetic disks, such as storage device 460. Volatile media includes dynamic memory, such as main memory 456. Transmission media includes coaxial cables, copper wire and fiber optics, including the wires that comprise bus 452. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 454 for execution. For example, the instructions may initially be carried on a magnetic disk of a remote computer. The remote computer can load the instructions into its dynamic memory and send the instructions over a telephone line using a modem. A modem local to computer system 450 can receive the data on the telephone line and use an infrared transmitter to convert the data to an infrared signal. An infrared detector can receive the data carried in the infrared signal and appropriate circuitry can place the data on bus 452. Bus 452 carries the data to main memory 456, from which processor 454 retrieves and executes the instructions. The instructions received by main memory 456 may optionally be stored on storage device 460 either before or after execution by processor 454.

Computer system 450 also includes a communication interface 469 coupled to bus 452. Communication interface 469 provides a two-way data communication coupling to a network link 470 that may be connected to a local network 472. For example, communication interface 469 may be an integrated services digital network (ISDN) card or a modem a data communication connection to a corresponding type of telephone line. As another example, communication interface 469 may be a local area network (LAN) card a data communication connection to a compatible LAN. Wireless links may also be implemented. In any such implementation, communication interface 469 sends and receives signals, such as electrical, electromagnetic or optical signals that carry digital data streams representing various types of information.

Network link 470 typically provides data communication through one or more networks to other data devices. For example, network link 470 provides a connection through local network 472 to a host computer 474 or to data equipment operated by an Internet Service Provider (ISP) 476. ISP 476 in turn provides data communication services through the worldwide packet data communication network now commonly referred to as the “Internet” 479. Local network 472 and Internet 479 both use electrical, electromagnetic or optical signals that carry digital data streams. The signals through the various networks and the signals on the network link 470 and through communication interface 469, which carry the digital data to and from computer system 450 are exemplary forms of carrier waves transporting the information.

Computer system 450 can send messages and receive data, including program code, through the network(s), network link 470 and communication interface 469. In the Internet example, a server 490 might transmit a requested code for an application program through Internet 479, ISP 476, local network 472 and communication interface 469. In accordance with the invention, one such downloaded application provides for values of Exchangeable Assets upon redemption of Component Instruments as described herein. Another such downloaded application provides for the net asset value of assets underlying Ordinary Redeemable Instruments which are Exchangeable Assets upon redemption of Component Instruments as described herein.

Processor 454 may execute the received code as it is received, and/or stored in storage device 460, or other non-volatile storage for later execution. In this manner, computer system 450 may obtain application code in the form of a carrier wave.

An alternative configuration involves, instead of access device 305 as a workstation linked by windows, an Internet web site allowing transactions directly over the Internet. Use of the system may still be restricted to brokers, if that were to be the objective, by suitable password procedures.

Access devices 305 may therefore include any device capable of interacting with computer system 450 or other service provider. Some exemplary devices may include, a personal digital assistant, a mobile phone, a smart phone, a tablet, a netbook, a notebook computer, a laptop computer, a terminal, a kiosk or other type of automated apparatus. Additional exemplary devices may include any device with a processor executing programmable commands to accomplish the steps described herein.

### EXAMPLES

It will be apparent to one skilled in the art that numerous embodiments of continuously offered Divisible Instruments and Component Instruments are possible.

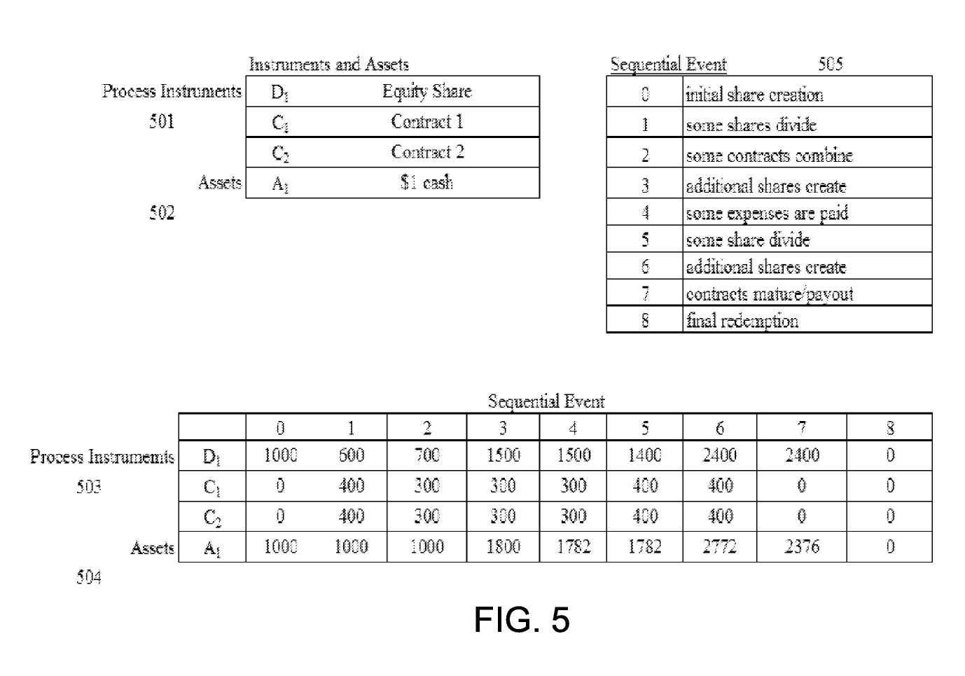

Referring now to FIG. 5, a spreadsheet illustrates some exemplary events and calculations of Process Instruments 503 and Assets 504 resulting from associated changes relating to Sequential Events 505. Process Instruments 503 are described as Process Instruments 501 and Assets 504 are described as Assets 502. Examples may include calculations for the numbers of Divisible Instruments, Component Instruments and Fund Assets comprising the instances of ongoing creation, division, combination, income, which can be implemented in the form of method steps on automated apparatus, such as a Creation Processor For Divisible Instruments. It is appreciated that in various embodiments certain events may be treated in a variety of different ways. For example, the payment of expenses or the attribution of income may be embedded in the terms of a Process Instrument that is adjusted for such expenses paid or income attributed.

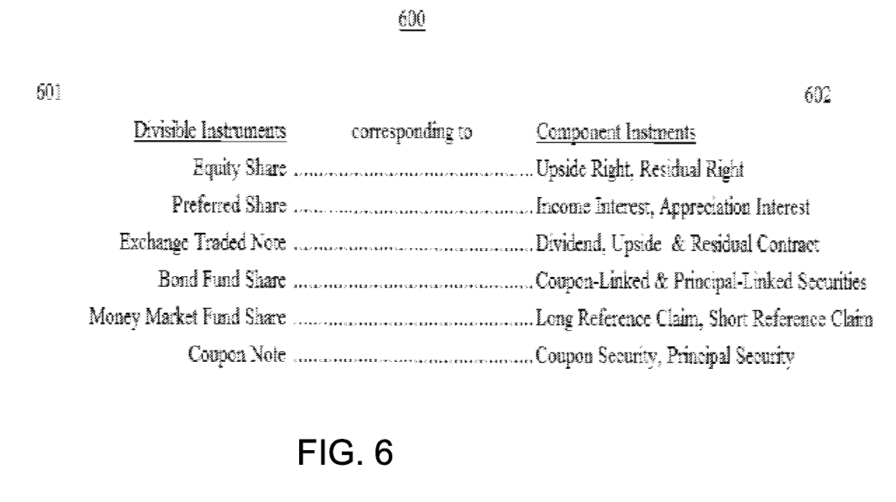

Referring to FIG. 6, a table 600 includes a list of Divisible Instruments 601 and corresponding exemplary Component Instruments 602. More specifically, the examples include: DI equity share dividing into and recombining from CI upside right and CI residual right; DI preferred share dividing into and recombining from CI income interest and CI appreciation interest; DI exchange traded note dividing into and recombining from CI dividend interest, CI upside interest and CI residual interest; DI bond fund share dividing into and recombining from CI coupon-linked security and CI principal-linked security; DI money market fund share dividing into and recombining from CI long reference claim and CI short reference claim; DI coupon note dividing into and recombining from CI coupon security and CI principal security.

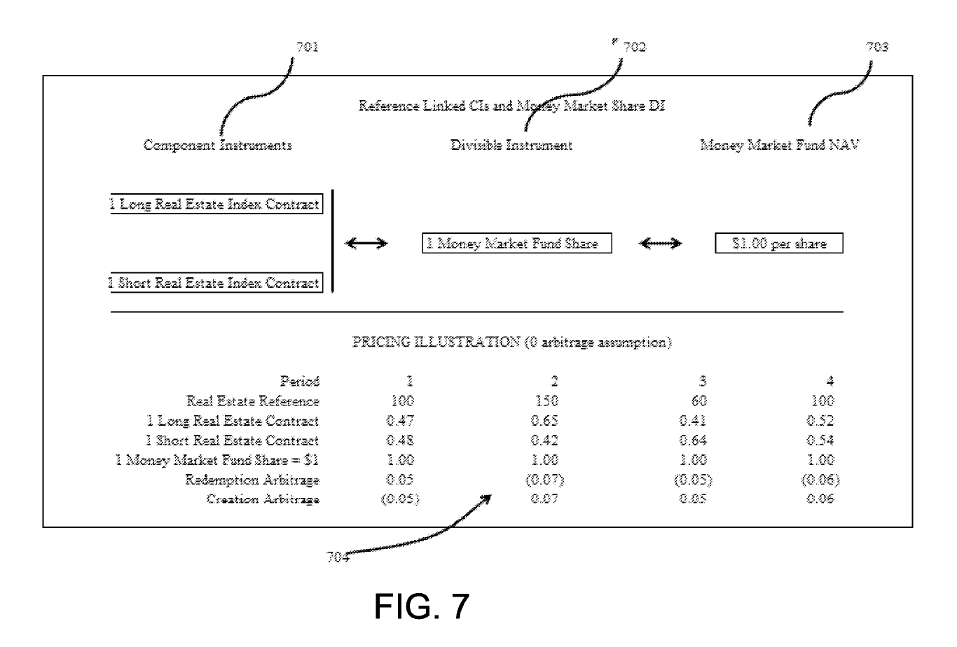

Referring now to FIG. 7, in the case of reference linked CIs and money market share DI, at 701 Component Instruments include two or more financial instruments, such as, for example, one or more contracts providing long exposure to a real estate index reference and one or more contracts providing short exposure to a real estate index reference dividing from and combining into 702 Divisible Instrument including one or more financial instruments, such as, for example one or more Money Market Fund shares which may or may not be listed and traded with NAV 703 equal to one dollar of U.S. currency. At 704, a table is included which illustrates a relative value of the Component Instruments and the Divisible Instruments at four different time periods. As illustrated, the arbitrage amount may be negative or positive during different periods. For simplicity, a bid-offer spread is not incorporated in the illustration.

### Discussion

Following now is a discussion including more detail relating to examples which exemplify some embodiments of the present invention. The discussion is meant to be illustrative and not limiting in character.

In some embodiments, the Process Instruments may be continuously offered by a legal entity such as a trust or corporation in a private placement exempt from registration under the 1933 Act. The Process Instruments may be resold in accordance with Rule 144A. Generally, Rule 144A permits the resale of certain unregistered securities to Qualified Institutional Buyers without requiring registration under the 1933 Act. Process instruments are traded on a private exchange enabling a certain amount of liquidity among institutional buyers without listing on a national exchange or registering under the Securities Exchange Act of 1934, and rely on Section 3(c)(7) of the Investment Company Act of 1940 which provides an exemption from its provisions for Qualified Purchasers.

The Process Instruments may comprise DIs comprising, for example, equity of a corporation which can be held, traded or divided into CIs comprising for example two disparate rights which can be held, traded separately or combined into a DI equity share. In some cases the DI equity share is created and redeemed like a fund, the System enabling creations to occur on an ongoing basis throughout the term of the issuer.

When a DI divides into two or more CIs, its characteristics, such as, for example, income, voting, and cash flow may allocate to the CIs based on the specification of these instruments. Each CI may include in its terms an aspect of the DI from which it was divided. Investment characteristics might be directly assigned, such as, for example, bond fund share DI divides into income right CI A and appreciation right CI B. Alternatively, the assignment of investment characteristic might be based on a formula or unrelated reference. For example, a public gold fund issues DI gold fund share dividing into CI GDP+ receiving 75% of net asset value at maturity if reported GDP rises and 25% if GDP falls, and CI GDP− receiving NAV per share not paid to CI GDP +.

The allocation of investment characteristics of DIs can be based on virtually any payoff formulation and underlying reference either singly or in combination including those that may or may not be possible to buy, hold, sell or otherwise invest in either directly or indirectly. Examples of such payoff formulations include any linear, exponential, digital or other mathematical formulation. Examples of such underlying references may include any flow, claim, return, price, level, outcome, statistical result, event or other measurable effect.

The System increases market interest in the issuer's securities by enabling investors seeking a subset of an issuer's DI investment characteristics to express that interest such that the aggregate demand for CIs causes the creation of additional DIs over time on a continuous basis in accordance with the capabilities of the Creation Processor For Divisible Instruments.

As discussed broadly above, aspects of the present invention may therefore include the following specific attributes, such as, apparatus and methods to create Divisible Instruments reversibly divisible into disparate Component Instruments comprising characteristics of the Divisible Instruments from which they derive on an ongoing basis.

In another aspect of the present invention an integrated financial system and method referred to herein as the Creation Processor For Divisible Instruments to create, divide, combine, redeem, distribute, manage and support Process Instruments on an ongoing basis is provided.

In another aspect of the present invention a method to facilitate transactions between buyers and sellers of Process Instruments is provided.

In still another aspect of the present invention a method for reporting upon Process Instruments is provided.

In another aspect of the present invention Process Instruments with enhanced trading characteristics associated with the ability to divide Divisible Instruments and combine Component Instruments is provided.

In another aspect of the present invention opportunities for investment, trading, speculation, hedging and arbitrage based on the interplay in price relationships among Divisible Instruments, Component Instruments, and underlying assets in the case of Divisible Instruments creating and redeeming for issuer net asset value is provided.

In another aspect of the present invention improved derivative instruments in the form of Component Instruments derived from Divisible Instruments with more flexible payout formulations, less counterparty risk, less market impact, increased marketability and improved pricing efficiency compared to derivative instruments is provided.

In another aspect of the present invention to enable issuer to transform their securities that are not Divisible Instruments into Divisible Instruments providing increased market interest.

In another aspect of the present invention a data processing system to enable the distribution and trading of Process Instruments is provided.

In another aspect of the present invention a data processing system to convey information about Process Instruments and prices in essentially real time is provided.

In some exemplary embodiments of the present invention, Divisible Instruments divide into more than one class of Component Instruments on an ongoing basis.

In some exemplary embodiments of the present invention, Divisible Instruments create and redeem for issuer net asset value on an ongoing basis as determined by the System.

In other exemplary embodiments the number of Component Instruments divided from a Divisible Instrument changes over time for reasons that may include changes in issuer expenses.

In other exemplary embodiments, one or more classes of Divisible Instruments specify that they are or may become Divisible Instruments in their offering documents.

In other exemplary embodiments, Component Instruments are specified in the offering documents associated with Divisible Instruments.

In other exemplary embodiments, Component Instruments are specified other than in the offering documents associated with Divisible Instruments.

In other exemplary embodiments, Divisible Instruments issue from a U.S. based issuer.

In other exemplary embodiments, Divisible Instruments issue from a non-U.S. based issuer.

In other exemplary embodiments, Divisible Instruments issue from a trust.

In other exemplary embodiments, Divisible Instruments issue from other than a trust.

In other exemplary embodiments, Divisible Instruments issue from a special purpose vehicle.

In other exemplary embodiments, Divisible Instruments issue from other than a special purpose vehicle.

In other exemplary embodiments, Divisible Instruments issue from a corporation.

In other exemplary embodiments, Divisible Instruments issue from other than a corporation.

In other exemplary embodiments, Divisible Instruments issue from a partnership.

In other exemplary embodiments, Divisible Instruments issue from other than a partnership.

In other exemplary embodiments, Divisible Instruments issue from a Real Estate

Investment Trust.

In other exemplary embodiments, Divisible Instruments issue from other than a Real Estate Investment Trust.

In other exemplary embodiments, Divisible Instruments issue from a Master Limited Partnership.

In other exemplary embodiments, Divisible Instruments issue from other than a Master Limited Partnership Trust.

In other exemplary embodiments, Divisible Instruments issue from a Grantor

Trust.

In other exemplary embodiments, Divisible Instruments issue from other than a Grantor Trust.

In other exemplary embodiments, Divisible Instruments issue from a Regulated Investment Company.

In other exemplary embodiments, Divisible Instruments issue from other than a Regulated Investment Company.

In other exemplary embodiments, Divisible Instruments issue from a pass through entity for Federal tax purposes.

In other exemplary embodiments, Divisible Instruments issue from other than a pass-through entity for Federal tax purposes.

In other exemplary embodiments, Divisible Instruments issue from a Registered Investment Company.

In other exemplary embodiments, Divisible Instruments issue from other than a Registered Investment Company.

In other exemplary embodiments, Divisible Instruments issue from a federal or state sanctioned exchange.

In other exemplary embodiments, Divisible Instruments issue from other than a federal or state sanctioned exchange.

In other exemplary embodiments, Divisible Instruments are not issued from a federal or state sanctioned exchange.

In other exemplary embodiments, Divisible Instruments are not issued from other than a federal or state sanctioned exchange.

In other exemplary embodiments, one or more Process Instruments are transferable.

In other exemplary embodiments, one or more Process Instruments are privately placed.

In other exemplary embodiments, one or more Process Instruments are other than privately placed.

In other exemplary embodiments, one or more Process Instruments are not privately placed.

In other exemplary embodiments, one or more Process Instruments are listed on a public exchange.

In other exemplary embodiments, one or more Process Instruments are listed on other than a public exchange.

In other exemplary embodiments, one or more Process Instruments are not listed on a public exchange.

In other exemplary embodiments, one or more Process Instruments are listed on other than a public exchange.

In other exemplary embodiments, one or more Process Instruments are not listed on other than a public exchange.

In other exemplary embodiments, one or more Process Instruments are transferred informally.

In other exemplary embodiments, one or more Process Instruments are transferred other than informally.

In other exemplary embodiments, one or more Process Instruments are not transferred informally.

In other exemplary embodiments, one or more Process Instruments are traded on a public exchange.

In other exemplary embodiments, one or more Process Instruments are not traded on a public exchange.

In other exemplary embodiments, one or more Process Instruments are traded on other than a public exchange.

In other exemplary embodiments, one or more Process Instruments are not traded on other than a public exchange.

In other exemplary embodiments, one or more Process Instruments are traded or not according to user instructions.

In other exemplary embodiments, one or more Process Instruments are traded among qualified investors in the 144A marketplace through a facility such as the NASDAQ PORTAL Alliance System.

In other exemplary embodiments, one or more Process Instruments are not traded among qualified investors in the 144A marketplace through a facility such as the NASDAQ PORTAL Alliance System.

In other exemplary embodiments, one or more Process Instruments are traded other than among qualified investors in the 144A marketplace through a facility such as the NASDAQ PORTAL Alliance System.

In other exemplary embodiments, one or more Process Instruments are not traded other than among qualified investors in the 144A marketplace through a facility such as the NASDAQ Portal facility.

What is claimed is:

1. A apparatus for the generation of divisible instruments repeatedly creating, the apparatus comprising:
a computer server accessible with a network access device via a communications network; and
executable software stored on the server and executable upon demand, the software operative with the server to cause the apparatus to:
receive data descriptive of a divisible instrument repeatedly creating;
receive data descriptive of two or more disparate component instruments;
specify a repeatedly creating divisible instrument dividing into two or more disparate component instruments; and
repeatedly creating divisible instruments comprising two or more component instruments.

2. The apparatus of claim 1 wherein divisible instruments create in exchange for depositing net asset value with the issuer.

3. The apparatus of claim 2 wherein creations and deposits occur on the initial offering and at least once thereafter.

4. The apparatus of claim 2 run in reverse wherein divisible instruments redeem in exchange for withdrawing net asset value from the issuer.

5. The apparatus of claim 1 wherein divisible instruments are newly issued financial instruments.

6. The apparatus of claim 5 wherein the newly issued financial instrument is an exchange traded product, exchange traded fund share or exchange traded note.

7. The apparatus of claim 1 wherein divisible instruments are existing financial instruments newly specified as divisible.

8. The apparatus of claim 7 wherein the existing financial instrument is an exchange traded product, exchange traded fund share or exchange traded note.

9. The apparatus of claim 1 wherein the descriptive data for the component instruments includes characteristics particular to the divisible instrument.

10. The apparatus of claim 9 wherein the characteristics particular to the divisible instrument include one or more of income, appreciation, economic returns, voting rights, purchase rights, corporate actions, among others.

11. The apparatus of claim 9 wherein the descriptive data for the component instruments includes characteristics that may not be particular to the divisible instrument.

12. The apparatus of claim 11 wherein the characteristics that may not be particular to the divisible instrument may include payout calculations.

13. The apparatus of claim 12 wherein the payout calculations are based on mathematical formula or references.

14. The apparatus of claim 13 wherein the mathematical formula are capped, uncapped, linear, exponential or digital among others.

15. The apparatus of claim 13 wherein the references are based on interest rates, economic or other statistics, market levels, indices, events, outcomes or other measureable effects, among others.

16. The apparatus of claim 1 wherein the executable software is additionally operative to transmit a description of an issuing entity of the divisible instrument.

17. The apparatus of claim 16 wherein the issuing entity comprises one of: a government, an operating company, a fund; and a special purpose vehicle.

18. The apparatus of claim 1 wherein the executable software is additionally operative to transmit a mechanism for performing a transaction involving one or more of divisible instruments and component instruments.

19. The apparatus of claim 18 wherein the executable software is additionally operative to transmit on an ongoing basis.

20. The apparatus of claim 19 wherein the executable software is additionally operative to receive a digital instruction to execute a creation of the divisible instrument.

21. The apparatus of claim 19 wherein the executable software is additionally operative to receive a digital instruction to execute redemption of the divisible instrument.

22. The apparatus of claim 19 wherein the executable software is additionally operative to receive a digital instruction to divide a divisible instrument into component instruments.

23. The apparatus of claim 19 wherein the executable software is additionally operative to receive a digital instruction to combine component instruments into a divisible instrument.

24. The apparatus of claim 18 wherein the executable software is additionally operative to receive a digital instruction to execute a generation of a market valuation for a divisible instrument based upon the terms of combining component instruments.

25. The apparatus of claim 18 wherein the executable software is additionally operative to receive a digital instruction to execute a generation of a market valuation for a component instrument based upon the terms of dividing a divisible instrument.

26. The apparatus of claim 18 wherein the executable software is additionally operative determine Net Asset Value and offer for sale value at a price based upon the Net Asset Value.

27. The apparatus of claim 18 wherein the executable software is additionally operative calculate Net Asset Value for divisible instruments.
